(19) United States
(12) Patent Application Publication
(10) Pub. No.: US 2021/0229280 A1
(43) Pub. Date: Jul. 29, 2021

(54) POSITIONING METHOD AND DEVICE, PATH DETERMINATION METHOD AND DEVICE, ROBOT AND STORAGE MEDIUM

(71) Applicant: SHANGHAI SENSETIME INTELLIGENT TECHNOLOGY CO., LTD., Shanghai (CN)

(72) Inventors: Chunxiao Liu, Shanghai (CN); Yu Liang, Shanghai (CN); Jianping Shi, Shanghai (CN); Haoxian Liang, Shanghai (CN); Xiaohui Lin, Shanghai (CN)

(21) Appl. No.: 17/227,915

(22) Filed: Apr. 12, 2021

Related U.S. Application Data
(63) Continuation of application No. PCT/CN2019/124412, filed on Dec. 10, 2019.

(30) Foreign Application Priority Data
Sep. 26, 2019 (CN) 201910915168.8

(51) Int. Cl. B25J 9/16; G06F 17/16; G06T 7/00

(52) U.S. Cl. CPC B25J 9/1664; B25J 9/1697; G06T 2207/20221; G06T 7/97; G06F 17/16

(57) ABSTRACT

A positioning method and device, a robot and a storage medium are provided. The positioning method includes: determining first position information of the robot by a positioning part; collecting an image by a camera; and determining second position information of the robot according to the image. The first position information and the second position information are fused to obtain the positioning information of the robot.

### CROSS-REFERENCE TO RELATED APPLICATIONS

This application is a continuation of International Patent application No. PCT/CN2019/124412, filed on Dec. 10, 2019, which claims priority to Chinese Patent Application No. 201910915168.8, filed on Sep. 26, 2019. The disclosures of International Patent application No. PCT/CN2019/124412 and Chinese Patent Application No. 201910915168.8 are incorporated herein by reference in their entireties.

### BACKGROUND

With the continuous development of electronic technology, unmanned robots, such as driverless vehicles have emerged. In order to allow an unmanned robot to move on the road, the location of the unmanned robot needs to be accurately positioned firstly so as to determine the subsequent driving path of the robot according to the positioning. At present, the commonly used positioning methods include: positioning by single-line laser radar, global positioning system (GPS) and other positioning parts.

### SUMMARY

The present disclosure relates to the technical field of robot, and particularly related to, but not limited to, a positioning method and device, a robot and a storage medium.

According to a first aspect, there is provided a positioning method, which includes the following operations. First position information of a robot is determined by a positioning part. An image is collected by a camera. Second position information of the robot is determined according to the image. The first position information and the second position information are fused to obtain positioning information of the robot.

According to a second aspect, there is provided a positioning device, which includes a processor and memory configured to store instructions executable by the processor. The processor is configured to: determine first position information of a robot by a positioning part; collect an image by a camera; determine second position information of the robot according to the image; and fuse the first position information and the second position information to obtain the positioning information of the robot.

According to a third aspect, there is provided a robot, which includes a processor, a memory, a positioning part, and a camera. The memory is configured to store computer program codes, the positioning part is configured to perform positioning, the camera is configured to collect images, and the processor is configured to implement the method of the first aspect as described above.

According to a fourth aspect, there is provided a readable storage medium, having stored therein a computer program, where the computer program includes a program code that, when executed by a processor, causes the processor to perform the method of the first aspect as described above.

### BRIEF DESCRIPTION OF THE DRAWINGS

FIG. 1 is a flowchart of a positioning method provided by an embodiment of the present disclosure.

FIG. 2 is a flowchart of another positioning method provided by an embodiment of the present disclosure.

FIG. 3 is a flowchart of a path determination method provided by an embodiment of the present disclosure.

FIG. 4 is a structural diagram of a positioning device provided by an embodiment of the present disclosure.

FIG. 5 is a structural diagram of a path determination device provided by an embodiment of the present disclosure.

FIG. 6 is a structural diagram of a robot provided by an embodiment of the present disclosure.

### DETAILED DESCRIPTION

Embodiments of the present disclosure n provide a positioning method, a path determination method, a robot and a storage medium, which are used for improving positioning accuracy. Detailed descriptions are given below.

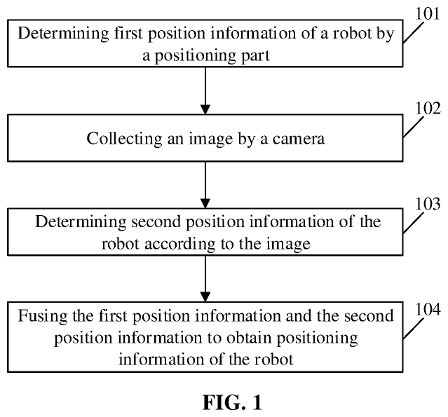

Referring to FIG. 1, FIG. 1 is a flowchart of a positioning method provided in an embodiment of the present disclosure. The positioning method is applied to a robot. The robot may be a tiny car for teaching, playing, etc., a bus or truck for carrying passengers or goods, etc., or a robot for teaching, playing, etc., and is not limited herein. The system used by the robot may be an embedded system or other systems, and is not limited herein. The steps of the positioning method can be executed by hardware such as a robot, or by a processor running computer executable codes. As shown in FIG. 1, the positioning method may include the follow operations.

In S101, first position information of a robot is determined by a positioning part.

The first position information is the position information of the robot itself determined by the positioning part. After the robot is powered on or started up, the first position information of the robot may be determined by the positioning part in real time or periodically. The positioning part may be laser radar, a global positioning system (GPS), an assisted global positioning system (AGPS), BeiDou positioning, etc. The laser radar may be single-line laser radar or multi-line laser radar and the period may be 1s, 2s, 5s, etc.

In the case that the positioning part is laser radar, positioning data may be collected by laser radar first. Then, the first position information of the robot is determined according to a point cloud positioning map and the positioning data, that is, points in the positioning data are matched with points in the point cloud positioning map. The position of the collected positioning data in the point cloud map may be determined through matching, thereby determining the first position information of the robot. The point cloud positioning map is a map for positioning, which is stitched according to point cloud. The point cloud positioning map may be stored in the robot in advance. In the case of using the point cloud positioning map, the stored point cloud positioning map needs to be obtained locally. In other implementations, the point cloud positioning map may also be stored in the cloud or other devices, and the robot may obtain it from the cloud or other devices when needed.

In S102, an image is collected by a camera.

After the robot is powered on or started up, mages may be collected by the camera in real time or periodically. The period herein may be the same as or different from the period in S101. The number of cameras may be one, or two or more.

In S103, second position information of the robot is determined according to the image.

After the image is collected by the camera, the second position information of the robot may be determined according to the collected image.

Specifically, the relative position between the robot and a marking object in the image may be determined first, and then the second position information of the robot may be determined according to the marking object and the relative position. Alternatively, the coordinates of the marking object in the image are determined first, then the relative position between the robot and the marking object in the image is determined according to the shooting angle of the camera relative to the marking object and the shooting proportion of the image, and the second position information of the robot is determined according to the marking object and the relative position. Alternatively, after the robot is identified according to the target identification technique, the robot position in the camera coordinate system is converted to the world coordinate system according to a preset coordinate conversion matrix to obtain the second position information of the robot.

When determining the relative position between the robot and the marking object in the image, the marking object in the image may be detected first, and then the relative position between the robot and the marking object may be determined according to an affine transformation matrix for the camera. Alternatively, the marking object in the image may be detected first, then the marking object is scanned with laser radar, and the relative position between the robot and the marking object is determined according to the points of the scanned marking object. The marking object may be traffic lights, road signs or other marking objects. In other embodiments, the relative distance between the robot and the marking object may also be measured by a distance sensor.

When determining the relative position between the robot and the marking object according to the affine transformation matrix for the camera, the coordinates of the marking object in the image coordinate system may be determined first, then according to the affine transformation matrix for the camera, the coordinates of the marking object in the image coordinate system are converted into the coordinates in the coordinate system with the camera as the origin, and finally the relative position between the robot and the marking object is determined according to the converted coordinates of the marking object. For example, if the coordinates of the robot in the coordinate system with the camera as the origin are (0, 0, 0) and the coordinates of the marking object in the coordinate system with the camera as the origin are (x1, y1, z1), the relative position between the robot and the marking object is (x1, y1, z1). Because there may be a deviation between the camera and the robot center, and extrinsic parameters of the camera and the robot center are measurable, the coordinates of the robot in the coordinate system with the camera as the origin may be further obtained in combination with the extrinsic parameters. The relative position of the marking object relative to the robot center (i.e. the robot) may be obtained according to the above process.

When determining the second position information of the robot according to the marking object in the image and the relative position between the robot and the marking object in the image, the second position information of the robot may be determined according to the first position information, a map, the marking object and the relative position. Specifically, the first position information may be converted into a position in the map to obtain the initial position information of the robot. At the same time (i.e., before or after the conversion step), the road sideline of the road where the robot is located may be identified from the image. For example, the lane line of the lane where a machine car is located is identified. The lateral information in the initial position information may be corrected according to the identified road sideline, and the longitudinal information in the initial position information may be corrected according to the relative position between the robot and the marking object in the image, so as to obtain the second position information of the robot.

The direction of the road sideline is longitudinal, and the direction perpendicular to the road sideline is lateral. The longitudinal information is the position information of the initial position information in the direction of the road sideline. The lateral information is position information of the initial position information in a direction perpendicular to the road side line. For example, the initial position information is lateral coordinates and longitudinal coordinates of the robot, where the lateral information is the lateral coordinates, and the longitudinal information is the longitudinal coordinates.

Correcting the longitudinal information in the initial position information according to the relative position between the robot and the marking object in the image may be that the coordinates (x1, y1, z1) of the marking object in the coordinate system with the camera as the origin are mapped to a map to obtain a mapped lateral position and a mapped longitudinal position, and the position of the marking object is directly queried from the map to obtain a query lateral position and a query longitudinal position. After that, the longitudinal position of the marking object may be obtained according to the mapped longitudinal position and the query longitudinal position, and the average or weighted average of the mapped longitudinal position and the query longitudinal position may be determined as the longitudinal position of the marking object. Then, the longitudinal information in the initial position information is corrected according to the relative position between the robot and the marking object in the image as well as the longitudinal position of the marking object. For example, the coordinates of the initial position information are (x2, y2), the longitudinal position of the marking object determined is y3, and the relative position between the robot and the marking object is (x1, y1, z1). It may be seen that the longitudinal coordinate difference between the marking object corresponding to the relative position and the robot is y1. The correction longitudinal information of the robot may be obtained according to y3−y1=y4, and the average or weighted average of y2 and y4 can be used as the longitudinal coordinate point of the robot.

Correcting the lateral information in the initial position information according to the identified road sideline may be that the midline of the road where the robot is located is determined according to the identified road sideline, then a point corresponding to the initial position information is determined in the midline, and the lateral information in the initial position information is corrected according to the lateral information of the point. The lateral information corrected may be an average or weighted average of the lateral information of the point and the lateral information in the initial position information. When the lane sideline is a straight line, the point in the midline, which corresponds to the initial position information, may be the same as a point corresponding to the longitudinal information of the initial position. When the lane sideline is a curve, the point corresponding to the initial position information in the midline may be the point closest to the initial position. For example, the coordinates of the initial position information are (x2, y2), the midline of the road where the robot is located may be determined according to the road sideline of the identified road, the abscissa of the midline is x3, and the average or weighted average of x2 and x3 may be used as the lateral coordinate point of the robot. In the case that the midline is not a straight line, x3 may be an abscissa of the point closest to (x2, y2) in the midline.

The map herein may be a high-precision map or a common physical positioning map. The high-precision map is an electronic map with higher precision and more data dimensions. The higher precision is reflected by the accuracy to centimeter level, and the more data dimensions are reflected by the map including surrounding static information related to driving besides road information. The high-precision map stores a large amount of robot driving assistance information as structured data, and the robot driving assistance information may be divided into two categories. The first category is road data, for example lane information such as the position, type, width, slope and curvature of road sideline. The second category is fixed object information around the road, such as traffic signs, traffic lights and other information, road height limit, sewer openings, obstacles and other road details, as well as infrastructure information such as elevated objects, fences, numbers, road edge types, roadside landmarks and the like. The road may be a lane, or a road such as sidewalks where robots can move. The road sideline is the side line of the road, which can be a lane line, a curb, an isolated object, or other things that can be used as the road sideline. The map is stored in the robot in advance, and the stored map may be obtained locally before use. In other implementations, the map may also be stored in the cloud or other devices, and may be obtained by the robot from the cloud or other devices when needed.

In S104, the first position information and the second position information are fused to obtain positioning information of the robot.

After the first position information of the robot is determined by the positioning part and the second position information of the robot is determined according to the image, the positioning information of the robot may be obtained by fusing the first position information and the second position information.

In a possible implementation, the first position information and the second position information may be input into the fusion algorithm to obtain the fusion positioning information and a confidence degree of the fusion positioning information. It is determined whether the confidence degree is greater than a threshold. When it is determined that the confidence degree is greater than the threshold, it indicates that the accuracy of the fused positioning information is high, and the fused positioning information may be determined as the positioning information of the robot. When it is determined that the confidence degree is less than or equal to the threshold, it indicates that the accuracy of the fused positioning information is low, and the fused positioning information may be discarded and then positioning is performed again. The positioning information of the robot may be an average, a weighted average, or the like of the first position information and the second position information. Fusion algorithms may be comprehensive average method, Kalman filter method, Bayesian estimation method and so on.

In other possible implementations, fusion processing, such as weighting or averaging, may also be directly performed on the first position information and the second position information to obtain the positioning information of the robot.

In the positioning method described in FIG. 1, during positioning, the positioning of the robot is obtained by fusing the positioning using the positioning part and the positioning from the image collected by the camera, which combines the positioning using the positioning part and the positioning based on the perception result, so that the positioning of the positioning part is corrected, thereby improving the positioning accuracy.

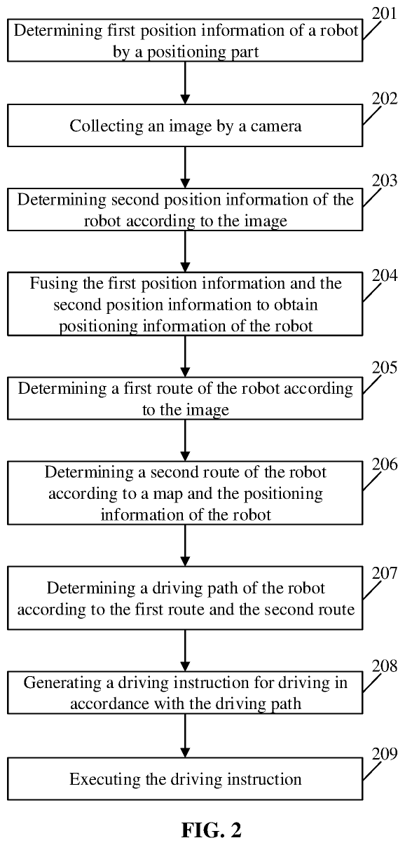

Referring to FIG. 2, FIG. 2 is a flowchart of another positioning method provided in an embodiment of the present disclosure. The positioning method is applied to a robot. The robot may be a tiny car for teaching, playing, etc., a bus or truck for carrying passengers or goods, etc., or a robot for teaching, playing, etc., and is not limited herein. The system used by the robot may be an embedded system or other systems, and is not limited herein. The steps of the positioning method can be executed by hardware such as a robot, or by a processor running computer executable codes. As shown in FIG. 2, the positioning method may include the follow operations.

In S201, first position information of a robot is determined by a positioning part.

S201 is the same as S101. The detailed description refers to the S101 and will not be elaborated herein for simplicity.

In S202, an image is collected by a camera.

S202 is the same as S102. The detailed description refers to the S102 and will not be elaborated herein for simplicity.

In S203, second position information of the robot is determined according to the image.

S203 is the same as S103. The detailed description refers to the S103 and will not be elaborated herein for simplicity.

In S204, the first position information and the second position information are fused to obtain positioning information of the robot.

S204 is the same as S104. The detailed description refers to the S104 and will not be elaborated herein for simplicity.

In S205, a first route of the robot is determined according to the image.

The first route is a driving path planned for the robot according to the collected image information. After the image is collected by the camera, the first route of the robot may be determined according to the image.

In a possible implementation, a vehicle is taken as an example of the robot. When the robot is driving on a straight road, the two road sidelines corresponding to the road where the robot is located may be identified in the image. For example, a pre-trained road sideline identification model is used to identify in the image the two road sidelines corresponding to the road where the robot is located, and then the midline of the two road sidelines is calculated. The midline of the road sideline may be directly determined as the first route of the robot, or the midline of the road sideline may be smoothed to obtain the first route of the robot. When the robot is driving on the rightmost or leftmost side of the road, the road where the robot is located may have only one road sideline, and the curb of the road detected in image detection may be determined as another road sideline. In condition that the road is bidirectional and the middle of the road is separated by objects such as fences, and when the robot is driving on the road beside the separated objects, the road where the robot is located may have only one road sideline, and the separated objects detected in image detection may be determined as another road sideline.

In a possible implementation, when the robot is driving through an intersection or curve, the first road sideline corresponding to the road where the robot is located may be identified in the image. The second road sideline of the road where the robot is located after turning may be determined according to the map and the positioning information of the robot, that is, the information of the road where the robot is located after turning may be queried in the map according to the positioning information of the robot. The information of the road may include the width of the road, the road sideline of the road where the robot is located, etc. Then, the entrance position and entrance direction of the road where the robot is located after turning are determined according to the identified first road sideline and the determined second road sideline. Since the accuracy of the first road sideline identified by the image is higher than that of the determined second road sideline, the determined road sideline may be completed according to the identified road sideline, and the entrance position and entrance direction of the road where the robot is driving on after turning can be determined according to the completed road sideline. Finally, the turning curve may be calculated according to the entrance position and direction of the road where the robot is located after turning, as well as the positioning information and direction of the robot, and the first route of the robot may be obtained. The turning curve may be calculated by using b-spline, polynomial fitting and other methods. In this way, the accuracy of planning the driving path for the robot can be improved, and the problem of inaccurate path planning caused by invisible part of the road sideline in blind area of the camera can be overcome.

In S206, a second route of the robot is determined according to a map and the positioning information of the robot.

The second route is a reference driving path of the robot planned according to the map and positioning information of the robot. After the positioning information of the robot is obtained by fusing the first position information and the second position information, the second route of the robot may be determined according to the map and the positioning information of the robot. When the robot is driving on a straight road, a midline of the road where the robot is currently located corresponding to the positioning information of the robot may be queried from the map, and the midline may be taken as the second route of the robot. When the robot is driving through an intersection, a midline of the road on which the robot will turn corresponding to the positioning information of the robot may be queried from the map, and the midline may be taken as the second route of the robot.

In other embodiments, other positions of the road, such as the route along the left ⅔ position of the road, may also be used as the second route of the robot.

In S207, a driving path of the robot is determined according to the first route and the second route.

After the first route of the robot is determined according to the image and the second route of the robot is determined according to the map and the positioning information of the robot, the driving path of the robot may be determined according to the first route and the second route. For example, the first route and the second route are aligned to obtain the driving path of the robot. The first route and the second route may be aligned using weighted averaging, curve fitting, etc.

In some embodiments, after S207, the method may include the following operations.

In S208, a driving instruction for driving in accordance with the driving path is generated.

After the driving path of the robot is determined according to the first route and the second route, a driving instruction for driving according to the driving path may be generated according to the driving path.

For example, in the case that the driving path is a straight line, a driving instruction for going straight for 100 meters according to the current road may be generated.

In S209, the driving instruction is performed.

After a driving instruction for driving according to the driving path is generated, the robot may perform the driving instruction to drive according to the driving path.

In the positioning method described in FIG. 2, the positioning of the robot is obtained by fusing the positioning using the positioning part and the positioning from the image collected by the camera, which combines the positioning using the positioning part and the positioning based on the perception result, so that the positioning using the positioning part is corrected, thereby improving the positioning accuracy. In addition, the driving path of the robot is determined according to the route of the robot determined by the positioning information and the route of the robot determined by the image collected by the camera, which combines the route of the robot determined by positioning information with the route of the robot determined by the image collected by the camera, so that the route of the robot determined by positioning information is corrected, thereby improving the accuracy of driving path determination.

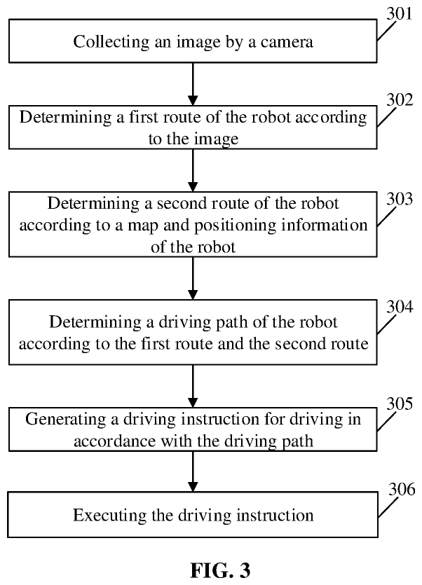

Referring to FIG. 3, FIG. 3 is a flowchart of a path determination method provided by an embodiment of the present disclosure. The path determination method is applied to a robot. The robot may be a tiny car for teaching, playing, etc., a bus or truck for carrying passengers or goods, etc., or a robot for teaching, playing, etc., and is not limited herein. The system used by the robot may be an embedded system or other systems, and is not limited herein. The steps of the positioning method can be executed by hardware such as a robot, or by a processor running computer executable codes. As shown in FIG. 3, the path determination method may include the follow operations.

In S301, an image by a camera is collected.

S301 is the same as S102. The detailed description refers to the S102 and will not be elaborated herein for simplicity.

In S302, a first route of the robot is determined according to the image.

S302 is the same as S205. The detailed description refers to the S205 and will not be elaborated herein for simplicity.

In S303, a second route of the robot is determined according to a map and the positioning information of the robot.

S303 is similar as S206. The detailed description refers to the S206 and will not be elaborated herein for simplicity.

In other embodiments, the robot may also directly obtain the positioning information of the robot by using the positioning part or based on the map, and then determine the first route and the second route of the robot.

In S304, a driving path of the robot is determined according to the first route and the second route.

S304 is the same as S207. The detailed description refers to the S207 and will not be elaborated herein for simplicity.

In S305, a driving instruction for driving in accordance with the driving path is generated.

S305 is the same as S208. The detailed description refers to the S208 and will not be elaborated herein for simplicity.

In S306, the driving instruction is performed.

S306 is the same as S209. The detailed description refers to the S209 and will not be elaborated herein for simplicity.

In the path determination method described in FIG. 3, the driving path of the robot is determined according to the route of the robot determined by the positioning information and the route of the robot determined by the image collected by the camera, which combines the route of the robot determined by positioning information with the route of the robot determined by the image collected by the camera, so that the route of the robot determined by positioning information is corrected, thereby improving the accuracy of driving path determination.

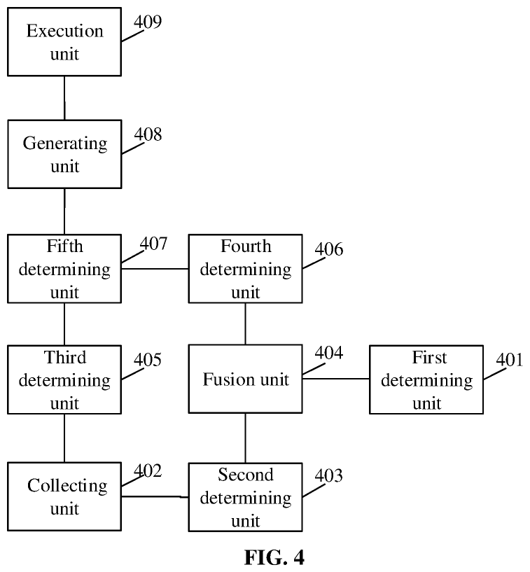

Referring to FIG. 4, FIG. 4 is a structural diagram of a positioning device provided in an embodiment of the present disclosure. The positioning device is applied to a robot. The robot may be a tiny car for teaching, playing, etc., a bus or truck for carrying passengers or goods, etc., and a robot for teaching, playing, etc., and is not limited herein. The system used by the robot may be an embedded system or other systems, and is not limited herein. The steps of the positioning method can be executed by hardware such as a robot, or by a processor running computer executable codes. As shown in FIG. 4, the positioning device may include a first determining unit 401, a collecting unit 402, a second determining unit 403 and a fusion unit 404.

The first determining unit 401 is configured to determine first position information of a robot by a positioning part.

The collecting unit 402 is configured to collect an image by a camera.

The second determining unit 403 is configured to determine second position information of the robot according to the image.

The fusion unit 404 is configured to fuse the first position information and the second position information to obtain the positioning information of the robot.

In an embodiment, the positioning part includes laser radar, and the first determining unit 401 is further configured to:

collect positioning data by the laser radar; and

determine the first position information of the robot according to a point cloud positioning map and the positioning data.

In an embodiment, the second determining unit 403 is further configured to:

determine a relative position between the robot and a marking object in the image; and

determine the second position information of the robot according to the marking object and the relative position.

In an embodiment, the second determining unit 403 is configured to determine a relative position between the robot and an marking object in the image by:

detecting the marking object in the image; and

determining the relative position between the robot and the marking object according to an affine transformation matrix for the camera.

In an embodiment, the second determining unit 403 is configured to determine the second position information of the robot according to the marking object and the relative position by:

determining the second position information of the robot according to the first position information, a map, the marking object and the relative position.

In an embodiment, the second determining unit 403 is configured to determine the second position information of the robot according to the first position information, the map, the marking object and the relative position by:

converting the first position information into a position in the map to obtain initial position information of the robot;

identifying in the image a road sideline of a road where the robot is located; and

correcting lateral information of the initial position information according to the identified road sideline and correcting longitudinal information of the initial position information according to the relative position to obtain the second position information of the robot.

The longitudinal information is the position information of the initial position information in a direction of the road sideline and the lateral information is the position information of the initial position information in a direction perpendicular to the road sideline.

In an embodiment, the fusion unit 404 is further configured to:

fuse the first position information and the second position information to obtain fused positioning information and a confidence degree of the fused positioning information; and

in condition that the confidence degree is greater than a threshold, determine the fused positioning information as the positioning information of the robot.

In an embodiment, the device further includes a third determining unit 405, a fourth determining unit 406 and a fifth determining unit 407.

The third determining unit 405 is configured to determine a first route of the robot according to the image.

The fourth determining unit 406 is configured to determine a second route of the robot according to a map and the positioning information of the robot.

The fifth determining unit 407 is configured to determine a driving path of the robot according to the first route and the second route.

In an embodiment, the third determining unit 405 is further configured to:

identify two road sidelines corresponding to a road where the robot is located in the image;

calculate a midline of the two road sidelines; and

perform curve smoothing processing on the midline to obtain the first route of the robot.

In an embodiment, the fourth determining unit 406 is further configured to query a midline of a road corresponding to the positioning information of the robot from the map to obtain the second route of the robot.

In an embodiment, the third determining unit 405 is further configured to:

identify a first road sideline corresponding to a road where the robot is located in the image;

determine, according to the map and the positioning information of the robot, a second road sideline of a road where the robot is located after turning;

determine, according to the first road sideline and the second road sideline, an entrance position and an entrance direction of the road where the robot is located after turning;

and

obtain the first route of the robot by calculating a turning curve to according to the entrance position, the entrance direction and the positioning information and direction of the robot.

In an embodiment, the fourth determining unit 406 is configured to query a midline of a turning road corresponding to the positioning information of the robot from the map to obtain the second route of the robot.

In an embodiment, the fifth determine unit 407 is configured to align the first route and the second route to obtain the driving path of the robot.

In an embodiment, the device further includes a generating unit 408 and an execution unit 409.

The generating unit 408 is configured to generate a driving instruction for driving in accordance with the driving path.

The execution unit 409 is configured to perform the driving instruction.

The embodiment may correspond to the description of the method embodiment in the embodiments of the disclosure, and the above and other operations and/or functions of each unit are used to implement the corresponding processes in each method in FIG. 1 and FIG. 2 respectively, which will not be elaborated herein for simplicity.

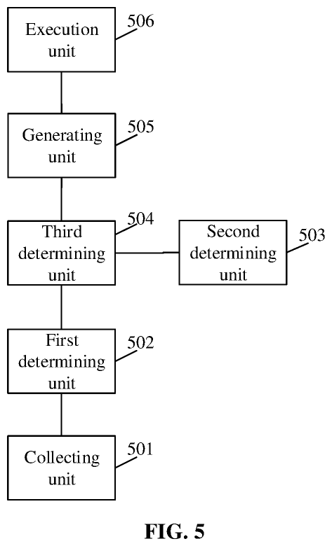

Referring to FIG. 5, FIG. 5 is a structural diagram of a path determination device provided in an embodiment of the present disclosure. The path determination device is applied to a robot. The robot may be a tiny car for teaching, playing, etc., a bus or truck for carrying passengers or goods, etc., or a robot for teaching, playing, etc., and is not limited herein. The system used by the robot may be an embedded system or other systems, and is not limited herein. The steps of the positioning method can be executed by hardware such as a robot, or by a processor running computer executable codes. As shown in FIG. 5, the path determination device may include a collecting unit 501, a first determining unit 502, a second determining unit 503 and a third determining unit 504.

The collecting unit 501 is configured to collect an image by a camera.

The first determining unit 502 is configured to determine a first route of the robot according to the image.

The second determining unit 503 is configured to determine a second route of the robot according to a map and the positioning information of the robot.

The third determining unit 504 is configured to determine a driving path of the robot according to the first route and the second route.

In an embodiment, the first determining unit 502 is further configured to:

identify in the image two road sidelines corresponding to a road where the robot is located;

calculate a midline of the two road sidelines; and

perform curve smoothing processing on the midline to obtain the first route of the robot.

In an embodiment, the second determining unit 503 is further configured to query a midline of a road corresponding to the positioning information of the robot from the map to obtain the second route of the robot.

In an embodiment, the first determining unit 502 is further configured to:

identify in the image a first road sideline corresponding to a road where the robot is located;

determine, according to the map and the positioning information of the robot, a second road sideline of a road where the robot is located after turning;

determine, according to the first road sideline and the second road sideline, an entrance position and an entrance direction of the road where the robot is located after turning; and

obtain the first route of the robot by calculating a turning curve according to the entrance position, the entrance direction and the positioning information and direction of the robot.

In an embodiment, the second determining unit 503 is further configured to query a midline of a turning road corresponding to the positioning information of the robot from the map to obtain the second route of the robot.

In an embodiment, the third determine unit 504 is configured to align the first route and the second route to obtain the driving path of the robot.

In an embodiment, the device further includes a generating unit 505 and an execution unit 505.

The generating unit 504 is configured to generate a driving instruction for driving in accordance with the driving path.

The execution unit 506 is configured to execute the driving instruction.

The embodiment may correspond to the description of the method embodiment in the embodiments of the disclosure, and the above and other operations and/or functions of each unit are used to implement the corresponding processes in each method in FIG. 2 and FIG. 3 respectively, which will not be elaborated herein for simplicity.

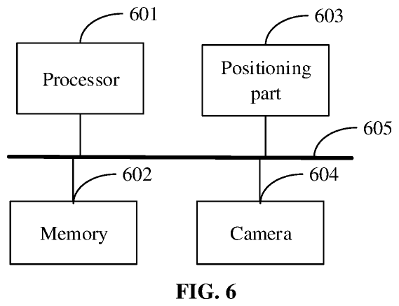

Referring to FIG. 6, FIG. 6 is a structural diagram of a robot provided in an embodiment of the present disclosure. The robot may be a tiny car for teaching, playing, etc., a bus or truck for carrying passengers or goods, etc., or a robot for teaching, playing, etc., and is not limited herein. The system used by the robot may be an embedded system or other systems, and is not limited herein. As shown in FIG. 6, the robot may include at least one processor 601, a memory 602, a positioning part 603, a camera 604, and a communication link 605. The memory 602 may exist independently, and may be connected to the processor 601 through the communication link 605. The memory 602 may also be integrated with the processor 601. The communication link 605 is used to realize the connection between these components.

In an embodiment, when computer program instructions stored in the memory 602 are executed, the processor 601 is configured to perform the operations of at least some of the second determination unit 403, the fusion unit 404, the third determination unit 405, the fourth determination unit 406, the fifth determination unit 407, the generation unit 408 and the execution unit 409 in the above embodiment. The positioning part 603 is configured to perform the operations performed by the first determination unit 401 in the above embodiment, and the camera 604 is configured to perform the operations performed by the collecting unit 402 in the above embodiment. The robot may also be configured to perform various methods performed by a terminal device in the aforementioned method embodiments, and will not be repeated herein.

In another embodiment, when the computer program instructions stored in the memory 602 are executed, the processor 601 is configured to perform the operations of the first determination unit 502, the second determination unit 503, the third determination unit 504, the generation unit 505 and the performing unit 505 in the above-mentioned embodiment, and the camera 604 is configured to execute the operations performed by the collecting unit 501 in the above-mentioned embodiment. The robot described above may also be configured to perform various methods performed in the aforementioned method embodiments and will not be repeated herein.

Embodiments of the present disclosure also disclose a computer-readable storage medium having stored thereon instructions, and the instructions, when being executed, implement the method in the foregoing method embodiments. The readable storage medium may be a volatile storage medium or a non-volatile storage medium.

Embodiments of the present disclosure also disclose a computer program product including instructions that, when being executed, implement the method in the foregoing method embodiments.

Those of ordinary skill in the art will appreciate that all or part of the steps in the various methods of the above embodiments can be accomplished by hardware associated with program instructions, and the program can be stored in a computer readable memory. The memory may include: Flash disk, Read-Only Memory (ROM), Random-Access Memory (RAM), magnetic disk or optical disk, etc.

The embodiments of the disclosure are described in detail above, and specific examples are used in this text to illustrate the principles and implementation of the disclosure. The descriptions of the above embodiments are only used to help understand the methods and core ideas of the disclosure; at the same time, for person of ordinary skill in the art, based on the ideas of the disclosure, will have changes in the specific implementation and scope of disclosure. In summary, the content of the specification should not be construed as a limitation on the disclosure.

1. A positioning method, comprising:
determining first position information of a robot by a positioning part;
collecting an image by a camera;
determining second position information of the robot according to the image; and
fusing the first position information and the second position information to obtain positioning information of the robot.

2. The method of claim 1, wherein the positioning part comprises laser radar, and determining the first position information of the robot by the positioning part comprises:
collecting positioning data by the laser radar; and
determining the first position information of the robot according to a point cloud positioning map and the positioning data.

3. The method of claim 1, wherein determining the second position information of the robot according to the image comprises:
determining a relative position between the robot and a marking object in the image; and
determining the second position information of the robot according to the marking object and the relative position.

4. The method of claim 3, wherein determining the relative position between the robot and the marking object in the image comprises:
detecting the marking object in the image; and
determining the relative position between the robot and the marking object according to an affine transformation matrix for the camera.

5. The method of claim 3, wherein determining the second position information of the robot according to the marking object and the relative position comprises:
determining the second position information of the robot according to the first position information, a map, the marking object and the relative position.

6. The method of claim 5, wherein determining the second position information of the robot according to the first position information, the map, the marking object and the relative position comprises:
converting the first position information into a position in the map to obtain initial position information of the robot;
identifying in the image a road sideline of a road where the robot is located; and
correcting lateral information of the initial position information according to the identified road sideline and correcting longitudinal information of the initial position information according to the relative position to obtain the second position information of the robot;
wherein the longitudinal information is position information of the initial position information in a direction of the road sideline and the lateral information is position information of the initial position information in a direction perpendicular to the road sideline.

7. The method of claim 1, wherein fusing the first position information and the second position information to obtain the positioning information of the robot comprises:
fusing the first position information and the second position information to obtain fused positioning information and a confidence degree of the fused positioning information; and
in condition that the confidence degree is greater than a threshold, determining the fused positioning information as the positioning information of the robot.

8. The method of claim 1, further comprising:
determining a first route of the robot according to the image;
determining a second route of the robot according to a map and the positioning information of the robot; and
determining a driving path of the robot according to the first route and the second route.

9. The method of claim 8, wherein determining the first route of the robot according to the image comprises:
identifying in the image two road sidelines corresponding to a road where the robot is located;
calculating a midline of the two road sidelines; and
performing curve smoothing processing on the midline to obtain the first route of the robot.

10. The method of claim 9, wherein determining the second route of the robot according the map and the positioning information of the robot comprises:
querying a midline of a road corresponding to the positioning information of the robot from the map to obtain the second route of the robot.

11. The method of claim 8, wherein determining the first route of the robot according to the image comprises:
identifying in the image a first road sideline corresponding to a road where the robot is located;
determining, according to the map and the positioning information of the robot, a second road sideline of a road where the robot is located after turning;
determining, according to the first road sideline and the second road sideline, an entrance position and an entrance direction of the road where the robot is located after turning; and
obtaining the first route of the robot by calculating a turning curve according to the entrance position, the entrance direction and the positioning information and direction of the robot.

12. The method of claim 11, wherein determining the second route of the robot according to the map and positioning information of the robot comprises:
querying a midline of a turning road corresponding to the positioning information of the robot from the map to obtain the second route of the robot.

13. The method of claim 8, wherein determining the driving path of the robot according to the first route and the second route comprises:
aligning the first route and the second route to obtain the driving path of the robot.

14. The method of claim 8, further comprising:
generating a driving instruction for driving in accordance with the driving path; and
executing the driving instruction.

15. A positioning device, comprising:
a processor; and
memory configured to store instructions executable by the processor,
wherein the processor is configured to:
determine first position information of a robot by a positioning part;
collect an image by a camera;
determine second position information of the robot according to the image; and
fuse the first position information and the second position information to obtain the positioning information of the robot.

16. The device of claim 15, wherein the positioning part comprises laser radar, and
the processor is further configured to:
collect positioning data by the laser radar; and
determine the first position information of the robot according to a point cloud positioning map and the positioning data.

17. The device of claim 15, wherein the processor is further configured to:
determine a relative position between the robot and a marking object in the image; and
determine the second position information of the robot according to the marking object and the relative position.

18. The device of claim 17, wherein the processor is configured to determine a relative position between the robot and a marking object in the image by:
detecting the marking object in the image; and
determining the relative position between the robot and the marking object according to an affine transformation matrix for the camera.

19. A robot, comprising a processor, a memory, a positioning part and a camera, wherein
the memory is configured to store a computer program code;
the positioning part is configured to perform positioning;
the camera is configured to capture an image; and
the processor is configured to invoke the computer program code to implement the method of claim 1.

20. A non-transitory readable storage medium, having stored a computer program thereon, wherein the computer program, when being executed by a processor, causes the processor to implement the following operations:
determining first position information of a robot by a positioning part;
collecting an image by a camera;
determining second position information of the robot according to the image; and
fusing the first position information and the second position information to obtain positioning information of the robot.
